(19) United States
(12) Patent Application Publication
(10) Pub. No.: US 2026/0204534 A1
(43) Pub. Date: Jul. 16, 2026

(54) A MASS SPECTROMETER AND A METHOD FOR ANALYZING A SAMPLE THEREIN

(71) Applicant: TELEDYNE FLIR DEFENSE, INC., North Billerica, MA (US)

(72) Inventor: DALTON SNYDER, West Lafayette, IN (US)

(21) Appl. No.: 19/135,151

(22) PCT Filed: Nov. 16, 2023
(86) PCT No.: PCT/US2023/079983

§ 371 Date: Jun. 3, 2025

Related U.S. Application Data
(60) Provisional application No. 63/386,346, filed on Dec. 7, 2022.
(60) Provisional application No. 63/386,347, filed on Dec. 7, 2022.
(60) Provisional application No. 63/386,348, filed on Dec. 7, 2022.

(51) Int. Cl. H01J 49/42; H01J 49/00

(52) U.S. Cl. CPC H01J 49/4225; H01J 49/0031

(57) ABSTRACT

Mass spectrometers and methods for analyzing a sample using a mass spectrometer are provided. The method includes applying a scan function to the ion trap including exciting at least a portion of the ions in the ion trap electively over time to fragment precursor ions into product ions and ejecting at least one of the product ions and the precursor ions from the ion trap. The mass spectrometer includes an ion trap and a controller configured to apply a scan function to the ion trap.

### CROSS-REFERENCE TO RELATED APPLICATIONS

This application claims the benefit of and priority under 35 U.S.C. § 119(e) to U.S. Provisional Application No. 63/386,346, filed Dec. 7, 2022, entitled “A MASS SPECTROMETER AND A METHOD FOR ANALYZING A SAMPLE THEREIN”, U.S. Provisional Application No. 63/386,347, filed Dec. 7, 2022, entitled “A MASS SPECTROMETER AND A METHOD FOR ANALYZING A SAMPLE THEREIN”, and U.S. Provisional Application No. 63/386,348, filed Dec. 7, 2022, entitled “A MASS SPECTROMETER AND A METHOD FOR ANALYZING A SAMPLE THEREIN”. The contents of each such application are hereby incorporated by reference in their entirety herein.

### FIELD OF USE

The present disclosure relates to mass spectrometers and methods for analyzing a sample using a mass spectrometer.

### BACKGROUND

A wide variety of materials require sensing and monitoring. These materials include weapons of mass destruction (WMD), such as chemical, biological, radioactive/nuclear, and explosive (CBRNE) materials, environmental pollutants, toxic industrial chemicals (TICS), drugs-of-abuse, and production byproducts associated with any of these materials. Challenges to detecting these materials include the presence of only very low levels of the materials and/or the presence of relatively large levels of environmental background interferent chemicals. Typically, detection involves using a highly selective sensor for the material of interest, but this approach limits the utility of the sensor to one class of materials or even to a single threat material. Another detection approach utilizes a more complex technique such as gas chromatography-mass spectrometry (GC/MS). In the GC/MS approach, GC is used to separate the target substance from background interferents, allowing use of MS to detect and identify the substance. MS is an analytical technique typically used to measure the mass to charge ratio of ions generated from an unknown sample, and the ratio is then used to identify the sample. Using GC for the separation can require cumbersome sample preparation steps prior to analysis, and the GC separation can take from 10 to 30 minutes or longer to perform. Also, there are challenges associated with properly identifying the separated sample using MS.

### SUMMARY

One non-limiting aspect of the present disclosure is directed to a method for analyzing a sample in a mass spectrometer. The method comprises storing ions produced from the sample in an ion trap of the mass spectrometer. The method comprises applying a scan function to the ion trap comprising exciting at least a portion of the ions in the ion trap selectively over time to fragment precursor ions into product ions and ejecting at least one of the product ions and the precursor ions from the ion trap. The scan function comprises a constant radio frequency voltage, a sweeping excitation frequency, and successive ejection frequency scans of variable duration and variable frequency range based on the sweeping excitation frequency.

Another non-limiting aspect of the present disclosure is directed to a mass spectrometer comprising an ion trap and a controller. The ion trap is configured to receive ions of a sample. The controller is configured to apply a scan function to the ion trap comprising exciting at least a portion of ions selectively over time to fragment precursor ions into product ions and ejecting at least one of the product ions and the precursor ions from the ion trap. The scan function comprises a constant radio frequency voltage, a sweeping excitation frequency, and successive ejection frequency scans of variable duration and variable frequency range based on the sweeping excitation frequency.

Yet another non-limiting aspect of the present disclosure is directed to a method for analyzing a sample in a mass spectrometer. The method comprises storing ions produced from the sample in an ion trap of the mass spectrometer. The method comprises applying a scan function to the ion trap comprising exciting at least a portion of the ions selectively over time, and ejecting at least one of product ions and precursor ions from the ion trap. The scan function comprises a sweeping radio frequency voltage, an excitation frequency, and successive ejection frequency scans. The sweeping radio frequency voltage is ramped from a first voltage to a second voltage greater than the first voltage.

Yet another non-limiting aspect of the present disclosure is directed to a mass spectrometer comprising an ion trap and a controller. The ion trap is configured to receive ions produced from a sample. The configured to apply a scan function to the ion trap comprising excite at least a portion of the ions selectively over time and eject at least one of product ions and precursor ions from the ion trap. The scan function comprises a sweeping radio frequency voltage, an excitation frequency, and successive ejection frequency scans. The sweeping radio frequency voltage is ramped from a first voltage to a second voltage greater than the first voltage.

One non-limiting aspect of the present disclosure is directed to a method for analyzing a sample in a mass spectrometer. The method comprises fragmenting at least a portion of the sample to form a first mixture comprising one or more precursor ions and first-generation product ions formed from dissociation of the precursor ions and storing the first mixture in an ion trap of the mass spectrometer. The method comprises applying a scan function to the ion trap comprising exciting at least a portion of the first mixture selectively over time to fragment the first-generation product ions into second-generation product ions and ejecting at least a portion of the precursor ions, the first-generation product ions, and second-generation product ions formed from the first-generation product ions by the scan function from the ion trap. The method comprises detecting at least a portion of the precursor ions, the first-generation product ions, and the second-generation product ions ejected from the ion trap and generating first spectrum data.

Another non-limiting aspect of the present disclosure is directed to a mass spectrometer comprising an ion trap and a controller. The ion trap is configured to receive a first mixture comprising one or more precursor ions of a sample and first-generation product ions formed from the precursor ions. The controller is configured to apply a scan function to the ion trap comprising excite at least a portion of the first mixture selectively over time to fragment the first-generation product ions into second-generation product ions and eject at least a portion of the precursor ions, the first-generation product ions, and the second-generation product ions formed from first-generation product ions from the ion trap.

One non-limiting aspect of the present disclosure is directed to a mass spectrometer comprising an ion trap, a controller, a first detector, and a second detector. The controller is configured to apply a scan function to the ion trap to eject ions in a first direction and eject ions in a second direction different than the first direction. The first detector is in a first location relative to the ion trap and configured to detect ions ejected from the ion trap in the first direction. The second detector in a second location relative to the ion trap and configured to detect ions ejected from the ion trap in the second direction. The second location is different than the first location.

Another non-limiting aspect of the present disclosure is directed to a method for analyzing a sample in a mass spectrometer. The method comprises providing ions produced from the sample in an ion trap of the mass spectrometer. The method comprises applying a scan function to the ion trap comprising exciting at least a portion of the ions selectively over time and ejecting at least one of product ions and precursor ions from the ion trap in a first direction and in a second direction different than the first direction. The scan function comprises a radio frequency voltage, an excitation frequency, a first ejection frequency for the first direction, and a second ejection frequency for the second direction.

It will be understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples presented herein, and the manner of attaining them, will become more apparent, and the examples will be better understood, by reference to the following description taken in conjunction with the accompanying drawings, wherein:

FIG. 1 is a flow diagram illustrating a non-limiting embodiment of a method for analyzing a sample in a mass spectrometer according to the present disclosure;

FIG. 2 is a schematic diagram of a non-limiting embodiment of a mass spectrometer according to the present disclosure;

FIG. 3 is a perspective view of a non-limiting embodiment of an ion trap according to the present disclosure;

FIG. 4 is a cross-sectional view of the ion trap of FIG. 3, taken along line 3-3;

FIGS. 5A-5C are graphs illustrating aspects of a non-limiting embodiment of a scan function according to the present disclosure, wherein the time scale in each graph is the same;

FIGS. 6A-6C are graphs illustrating aspects of a non-limiting embodiments of a scan function according to the present disclosure, wherein the time scale in each graph is the same;

FIG. 7 is a perspective view of non-limiting embodiments of an ion trap and two detectors according to the present disclosure;

FIG. 8 is a cross-sectional view of FIG. 7, taken along line 7-7;

FIGS. 9A-9D are graphs illustrating a non-limiting embodiments of a scan function according to the present disclosure, wherein the time scale in each graph is the same;

FIG. 10 is a schematic diagram of a non-limiting embodiment of a mass spectrometer according to the present disclosure;

FIG. 11 shows certain spectrum data determined using an MS according to a comparative example;

FIG. 12 shows certain spectrum data determined using an MS according to a non-limiting embodiment of the present disclosure;

FIG. 13 shows certain spectrum data determined using an MS according to a comparative example;

FIG. 14 shows certain spectrum data determined using an MS according to a non-limiting embodiment of the present disclosure; and

FIG. 15 shows certain spectrum data determined using an MS according to a non-limiting embodiment of the present disclosure.

The exemplifications set out herein illustrate certain non-limiting embodiments, in one form, and such exemplifications are not to be construed as limiting the scope of the appended claims and the invention in any manner.

### DETAILED DESCRIPTION OF NON-LIMITING EMBODIMENTS

Various examples are described and illustrated herein to provide an overall understanding of the structure, function, and use of the disclosed systems, apparatus, and methods. The various examples described and illustrated herein are non-limiting and non-exhaustive. Thus, the invention is not limited by the description of the various non-limiting and non-exhaustive examples disclosed herein. Features and characteristics illustrated and/or described in connection with various examples herein may be combined with features and characteristics of other examples herein. Such modifications and variations are intended to be included within the scope of the present disclosure. The various non-limiting embodiments disclosed and described in the present disclosure can comprise, consist of, or consist essentially of the features and characteristics as variously described herein.

Any references herein to “various non-limiting embodiments”, “some non-limiting embodiments”, “certain non-limiting embodiments”, “one non-limiting embodiment”, “a non-limiting embodiment”, “an embodiment”, “one embodiment”, or like phrases mean that a particular feature, structure, act, or characteristic described in connection with the example is included in at least one embodiment. Thus, appearances of the phrases “various non-limiting embodiments”, “some non-limiting embodiments”, “certain non-limiting embodiments”, “one non-limiting embodiment”, “a non-limiting embodiment”, “an embodiment”, “one embodiment”, or like phrases in the specification do not necessarily refer to the same non-limiting embodiment. Furthermore, the particular described features, structures, or characteristics may be combined in any suitable manner in one or more non-limiting embodiments. Thus, the particular features, structures, or characteristics illustrated or described in connection with one non-limiting embodiment may be combined, in whole or in part, with the features, structures, or characteristics of one or more other non-limiting embodiments without limitation. Such modifications and variations are intended to be included within the scope of the present non-limiting embodiments.

As used herein, “at least one of” a list of elements means one of the elements or any combination of two or more of the listed elements. As an example “at least of A, B, and C” means A only; B only; C only; A and B; A and C; B and C; or A, B, and C.

As used herein, “ion” or “ions” without an adjective immediately prior to the term can include one or more of precursor ions, first-generation product ions, second-generation product ions, third-generation product ions, and further generations of product ions, depending on the application.

Tandem mass spectrometry (MS/MS) can be used to detect and identify a target in a complex mixture if the target is known so the MS/MS apparatus can be set up to collect appropriate spectrum data. This can limit the number and types of substances that one can detect by this method. Further, mass spectrometers may be large, heavy, and difficult to operate, have large power requirements, and require long analysis times. Additionally, certain mass spectrometry methods may not be suitable for testing a sample that includes a mixture of two or more different samples. In light of these issues, the present disclosure provides a mass spectrometer that can have a reduced size and/or weight, provide increased accuracy, be easier to use, require less power, and/or decrease analysis time. The present disclosure also provides improved methods for detecting target materials using a mass spectrometer.

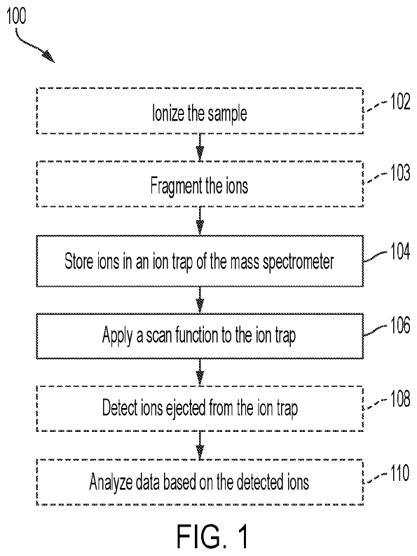

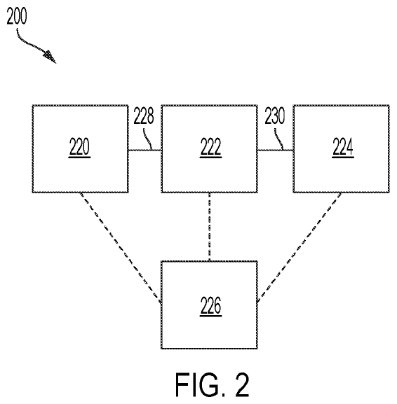

FIG. 1 schematically illustrates a non-limiting method 100 for analyzing a sample using a mass spectrometer. Method 100 can be performed using, for example, a mass spectrometer 200 as described with respect to FIG. 2 below. Referring again to FIG. 1, the method 100 can ionize the sample and measure a mass-to-charge ratio (m/z) of the ions generated. The sample can comprise a homogenous or heterogeneous mixture of chemical compounds. The sample can be introduced to the mass spectrometer for example, by injection, actively sample the surrounding environment, and/or otherwise receive a sample provided to it or that it encounters.

As illustrated in FIG. 1, method 100 can optionally (boxed in broken lines) comprise ionizing at least a portion of the sample at step 102. In various non-limiting embodiments, ionization can comprise electrospray ionization and/or other ionization technique. In certain non-limiting embodiments of method 100, precursor ions can be produced by ionizing the sample and can be unfragmented. Ionization electrically charges a molecule and thereby generates an ion from the molecule through gain or loss of one or more electrons and/or charged particle (e.g. proton, sodium ion, chloride ion) from the molecule. For example, the precursor ions can be the individual molecules in the sample modified by addition of an electrical charge.

The method 100 can optionally comprise fragmenting at least a portion of the sample and/or ions, at step 103. For example, fragmenting precursor ions forms first-generation product ions, fragmenting first-generation product ions forms second-generation product ions, and fragmenting second-generation product ions forms third-generation product ions. The product ions can be fragmented a number of times based on the desired application and may be fragmented to third-generation product ions or further. Fragmenting is a chemical disassociation caused by, for example, the removal of at least one electron from an ion, collision with a gas molecule and/or solid surface, electron capture or transfer, and/or ultraviolet and/or infrared photon absorption. The m/z values of the ions generated may be the same or different. In various non-limiting embodiments, fragmenting at least the portion of the sample can comprise at least one of in-source collision induced dissociation, beam-type collision induced dissociation, collision induced dissociation by resonance excitation, surface-induced dissociation, infrared multiphoton dissociation, ultraviolet photodissociation, electron capture dissociation, electron transfer dissociation, and electron impact dissociation.

In various non-limiting embodiments, fragmenting at least a portion of the sample and/or ions at step 103 can occur prior to introducing the ions and/or sample to the ion trap. In various other non-limiting embodiments, fragmenting at least a portion of the sample and/or ions at step 103 can occur within the ion trap. In various non-limiting embodiments, fragmenting at least a portion of the sample and/or ions at step 103 can occur before the ion trap in a collision device. For example, fragmenting at least the portion of the sample and/or ions at step 103 can comprise beam type collision induced dissociation within the collision cell prior to the ion trap. In various non-limiting embodiments, fragmenting at least the portion of the sample and/or ions at step 103 can comprise at least one of beam type collision induced dissociation within the ion trap and collision induced dissociation by resonance excitation within the ion trap.

In certain non-limiting embodiments, fragmenting at least the portion of the sample and/or ions at step 103 is performed over a range of different collision energies (e.g., by varying the ion's acceleration prior to the collision device) within the collision cell. In various non-limiting embodiments, fragmenting at least a portion of the sample and/or ions at step 103 can occur both in a collision device and within the ion trap. The ions can be fragmented based on their m/z value and applied electric fields such that an m/z value of the ion that was fragmented can be determined based the applied electric field and thus based on a time of detection.

As illustrated, the method 100 comprises storing the ions in an ion trap of the mass spectrometer, at step 104. For example, at least one of precursor ions produced from the sample, first-generation product ions produced from precursor ions, second-generation product ions produced from the first-generation product ions, third-generation product ions produced from the second-generation product ions, and further generation product ions can be stored in the ion trap.

As illustrated in FIG. 1, the method 100 comprises applying a scan function to the ion trap, at step 106. Applying the scan function can comprise exciting at least a portion of the ions in the ion trap selectively over time to fragment ions into product ions and ejecting ions from the ion trap. In various non-limiting embodiments, at least one of a precursor ion can be fragmented into first-generation product ions, a first-generation product ion can be fragmented into second-generation product ions, a second-generation product ion can be fragmented into third-generation product ions, or further generation product ion can be fragmented by the scan function. In various non-limiting embodiments, fragmenting is performed on ions with relatively low m/z values first, and fragmenting is next performed on ions with successively greater m/z values. In certain non-limiting embodiments, at least one of a precursor ion, a first-generation product ion, a second-generation product ion, a third-generation product ion, or a further generation product ion can be ejected from the ion trap by the scan function.

The scan function can produce one further generation of ions from ions and/or sample stored in the ion trap. For example, a single scan function may fragment a first-generation product ion into a first set of second-generation product ions, but the single scan function may not further fragment the second-generation product ions. In various non-limiting embodiments, the second-generation product ions can be stored in the ion trap and fragmented into third-generation product ions. Certain scan functions can fragment ions within the ion trap and may not eject ions from the ion trap. Thus, the scan functions can be applied until a desired generation of product ions is achieved.

The scan function comprises exciting at least a portion of the ions in the ion trap selectively over time to fragment precursor ions into product ions and ejecting at least one of the product ions and the precursor ions from the ion trap. For example, the scan function may comprise a radio frequency (RF) voltage (e.g., a trapping voltage), an excitation frequency, and an ejection frequency. The RF voltage, the excitation frequency, and the ejection frequency can be applied to electrodes in the ion trap to form a dynamic electric field within the ion trap configured to control (e.g., store, eject) the ions as desired. For example, the scan function can store ions based on an m/z value of the ions and/or eject ions based on an m/z of the ions such that the ions can be sorted based on the m/z value of the respective ion.

The RF voltage can store ions in the ion trap. For example, the RF voltage can store ions in the ion trap based on the secular frequency of ions in the ion trap such that the ions oscillate within a potential well in the ion trap. The RF voltage can be selected based on the desired m/z values to be stored in and/or ejected from the ion trap. In various non-limiting embodiments, the RF voltage can be in a range of 50 to 5,000 volts.

The excitation frequency can excite ions in the ion trap to fragment the ions. For example, the excitation frequency can bring the secular frequency of ions into resonance with the excitation frequency based on the m/z value of the ion. Changing the excitation frequency and/or the RF voltage can change the ions that are in resonance with the excitation frequency. Resonance can occur when the secular frequency of the respective ion matches (e.g., or otherwise comes close to matching) the excitation frequency, which can cause the ions to become kinetically excited and collide with other molecules in the ion trap. The other molecules in the ion trap can be molecules of a gas, such as, for example, helium, nitrogen, air, and/or other gas. The collision can cause the fragmentation of the ions. For example, a precursor ion can be fragmented into first-generation product ions, a first-generation product ion can be fragmented into second-generation product ions, a second-generation product ion can be fragmented into third-generation product ions, and further generation product ions can be fragmented. In various non-limiting embodiments, the excitation frequency can be in a range of 1 MHz to 2 MHz. In certain non-limiting embodiments, the ejection frequency can be in a range of 20 kHz to 1 MHz.

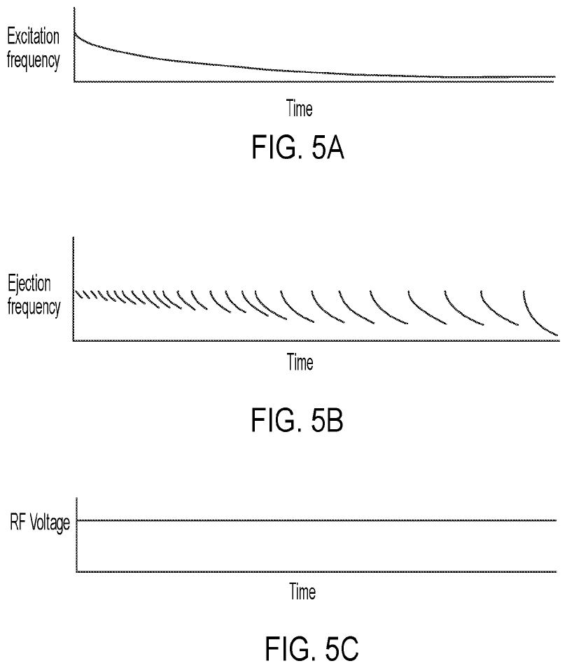

In various non-limiting embodiments, a scan function comprises a constant RF voltage (e.g., FIG. 5A), a sweeping excitation frequency (e.g., FIG. 5B), and successive ejection frequency scans of variable duration and variable frequency range based on the sweeping excitation frequency (e.g., 5C). As illustrated in FIG. 5C, the constant RF voltage can be a high voltage signal (e.g., relative to the excitation frequency and ejection frequency, a range of 100 volts to greater than 1000 volts) configured to store the ions in the ion trap. As used herein, a “constant” means the frequency or voltage does not deviate from a predetermined value by more than 0.2%, such as, for example, no more than 0.1%. As illustrated in FIG. 5A, the sweeping excitation frequency can be a low AC voltage (e.g., relative to the RF voltage, 100 mV to less than 100 voltages) auxiliary waveform configured to excite the ions to fragment the ions in the ion trap. The sweeping excitation frequency may excite lower m/z value ions by starting at a first frequency and may proceed to excite higher m/z value ions by lowering the applied frequency over time. In various non-limiting embodiments, the mass scan rate can be constant.

In various non-limiting embodiments, the sweeping excitation frequency sweeps from a first frequency to a second frequency that is less than the first frequency. The sweep from the first frequency to the second frequency can be linear, nonlinear, parabolic, inverse Mathieu (e.g., such that time is proportional to 1/q, where q is the excited ion's Mathieu q value), or other suitable sweep. In various non-limiting embodiments, the sweeping excitation frequency spans a Mathieu q range for the ions in the ion trap (e.g., q=0.1 to 0.908). In various non-limiting embodiments wherein the sweep from the first frequency to the second frequency is an inverse Mathieu q range sweep, the relationship between the excited precursor ion m/z value and time of detection can be linear, which can simplify mass calibration and increase processing speed.

As illustrated in FIG. 5B, in certain embodiments the successive ejection frequency scans of variable duration and variable frequency range can be low AC voltage (e.g., relative to the RF voltage, 100 mV to less than 100 voltages) auxiliary waveforms. The successive ejection frequency scans can excite ions based on their respective m/z values such that the ions are ejected from the ion trap and detected. One scan of the ejection frequency scans is a sinusoidal frequency sweep, which can be from a high frequency to a low frequency (e.g., from a low m/z to a high m/z), and a new scan is started when the ejection frequency reaches a terminal value (e.g., equal to the excitation frequency) and is then returned (e.g., increased) to a starting position (e.g., 1/2 the RF frequency). For example, as the sweeping excitation frequency decreases (e.g., as ions with larger m/z values are excited), the frequency range of each scan of the successive frequency scans may increase to span the m/z value range of product ions (e.g., larger m/z value range) that would be expected to form by excitation and dissociation of an ion based on the excitation frequency. The duration of each scan may be adjusted based on the frequency range of each scan and can be nonlinear. For example, as the frequency range of each scan increases, the duration of each scan may increase. In various non-limiting embodiments, each scan of the successive ejection frequency scans comprises a frequency range greater than a frequency range of an immediately preceding scan of the successive ejection frequency scans. In certain non-limiting embodiments, the frequency range of each scan can span from half of the RF voltage down to a precursor ion excitation frequency. In various non-limiting embodiments, half of the RF voltage corresponds to the ions at the Mathieu stability boundary of q=0.908 in a sinusoidally driven ion trap. In various non-limiting embodiments, the excitation frequency can occur for a time period in a range of 100 milliseconds (ms) to 10 seconds.

The scan function embodiment illustrated in FIGS. 5A-C can be configured to analyze only the expected m/z range of each precursor ion and fragments thereof and may not include an entire m/z value range. The precursor ions can be analyzed more efficiently and the product ions can be analyzed more often. Thus, increases in density of data for the precursor ions, in sensitivity of detection, and in the signal-to-noise ratio can be achieved.

For example, in certain embodiments the sweeping excitation frequency can excite a first precursor ion at a first excitation frequency to form a first set of product ions from dissociation of the first precursor ion. A first scan of the successive ejection frequency scans can sequentially eject the first set of product ions from the ion trap based on their respective m/z value. As the sweeping excitation frequency changes, a second precursor ion can be excited at a second excitation frequency to form second set of product ions from dissociation of the second precursor ion. A second scan of the successive ejection frequency scan can sequentially eject the second set of product ions from the ion trap based on their respective m/z value. In various non-limiting embodiments, the first precursor ion can comprise a first m/z value that is less than a second m/z value of the second precursor ion, and the first scan can be performed for a first duration that is less than a second duration of the second scan. In certain non-limiting embodiments, the first scan can be performed over a first frequency range that is less than a second frequency range of the second scan.

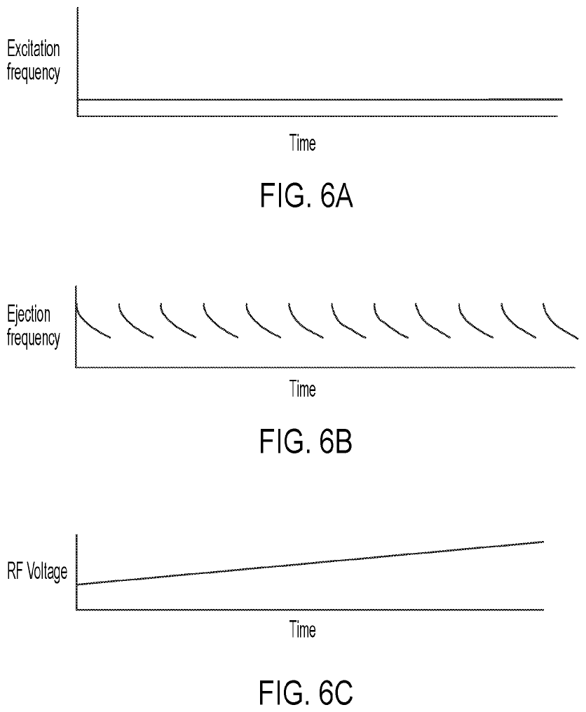

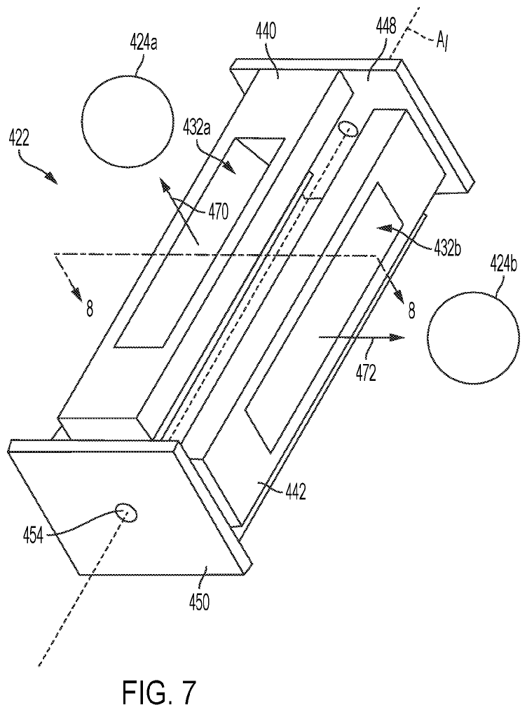

In certain non-limiting embodiments, the scan function comprises a sweeping RF voltage (e.g., FIG. 6C), an excitation frequency that can vary with time or be constant (e.g., FIG. 6A), and successive ejection frequency scans (e.g., FIG. 6B). As illustrated in FIG. 6A, in certain embodiments the excitation frequency can be constant. The excitation frequency can be set at a Mathieu q value in a range of, for example, 0 to 0.908, such as, for example, 0.1 to 0.4.

As illustrated in FIG. 6C, in certain embodiments the sweeping RF voltage can be ramped from a first voltage to a second voltage greater than the first voltage. The ramp of the sweeping RF voltage can be linear, nonlinear, parabolic, or other suitable sweep. In various non-limiting embodiments, the ramp from the first voltage to the second voltage is linear. Changing the RF voltage can change the ions that oscillate within the ion trap, thereby causing ions to resonate with the excitation frequency. For example, if the RF voltage is ramped linearly, the relationship between the m/z value of the excited ion and time can be linear. In various embodiments, the RF voltage can be ramped over a time period in a range of 100 ms to 2 seconds, such as, for example, 200 ms to 1 second or 300 ms to 900 ms.

In certain embodiments, each scan of the successive ejection frequency scans can comprise the identical predetermined duration and/or identical predetermined frequency range. As the ions are excited, a scan of the ejection frequency scans can eject the product ions as they are formed from the excitation and resulting dissociation of the ions. For example, each scan can span a frequency range from half the RF voltage to the excitation frequency (e.g., FIG. 6B). Each scan can be linear, nonlinear, parabolic, inverse Mathieu, or other suitable sweep. In various embodiments, each scan can be configured such that the relationship between the m/z of each product ion and time is linear to reduce the complexity of the calibration needed. The duration of each scan be in a range of 0.1 ms to 10 ms, such as, for example, 0.2 ms to 5 ms or 0.5 ms to 2 ms.

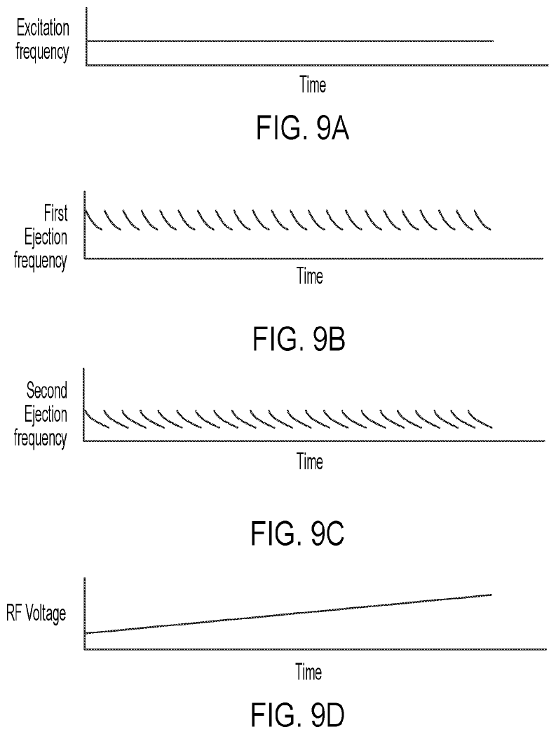

In various non-limiting embodiments, the scan function can eject ions in at least two directions. For example, the scan function can comprise an RF voltage (e.g., FIG. 9D), an excitation frequency (e.g., 9A), first ejection frequency scans for the first direction (e.g., 9B), and second ejection frequency scans for the second direction (e.g., 9C). As illustrated in FIGS. 9A and 9D, the excitation frequency can be applied substantially similarly to the excitation frequency discussed with respect to FIG. 6A above, and the RF voltage can be applied substantially similarly to the RF voltage discussed with respect to FIG. 6C above. In various non-limiting embodiments, the excitation frequency can be applied in a manner substantially similar to the excitation frequency discussed with respect to FIG. 5A above, and the RF voltage can be applied in a manner substantially similar to the RF voltage discussed with respect to FIG. 5C above.

The first ejection frequency and the second ejection frequency can be applied to an ion trap at the same time or at different times. In various embodiments, the first ejection frequency and the second ejection frequency can be configured to span different frequency ranges and may not overlap, thereby ejecting ions with different m/z values, which may increase speed of the analysis. For example, the first ejection frequency can eject ions having m/z values in a first m/z value range in a first direction towards a first detector, and the second ejection frequency can eject ions having m/z values in a second m/z value range in a second direction towards a second detector. In various non-limiting embodiments, the first m/z range can be lower than the second m/z range. In various non-limiting embodiments, the scan function comprises applying a first ejection frequency to a first set of two opposing electrodes of the ion trap, applying a second ejection frequency to a second set of two opposing electrodes of the ion trap, and applying an excitation frequency to at least one of the first set and the second set, wherein the first set comprises the first electrode and the second set comprises the second electrode and no electrode in the first set is in the second set.

In certain embodiments, the first ejection frequency and the second ejection frequency can be configured to at least partially overlap, thereby creating orthogonal detection of ions with the same m/z values, which may increase data quality. In various non-limiting embodiments, the first ejection frequency and the second ejection frequency can be configured to wholly overlap.

Noise can originate from ejection of unfragmented precursor ions or production of fragment ions with m/z values less than a lower m/z cutoff (e.g., ions that are immediately ejected from the ion trap due to trajectory instability). The noise can be reduced, for example, by the scan function described with respect to FIGS. 5A-5C, the scan function described with respect to FIGS. 6A-6C, or the scan function described with respect to FIGS. 9A-9D. In various non-limiting embodiments, the noise can be reduced by selecting which of pair of opposing electrodes the excitation frequency is applied to. For example, the excitation frequency can be combined on the same rods as one or both excitation frequency.

Referring back to FIG. 1, the method 100 can optionally comprise detecting ions ejected from the ion trap and generating spectrum data based on the detected ions, at step 108. The ions can be detected with a single detector or two or more detectors. For example, at least one of a precursor ion, a first-generation product ion, a second-generation product ion, a third-generation product ion, or a further generation product ion can be detected at step 108. The spectrum data can be, for example, a data set of ion abundance versus time. In various non-limiting embodiments, the spectrum data can be, for example, a two-dimensional data set with respect to mass (e.g., two dimensions of m/z).

The data can be analyzed at step 110. The analysis can comprise correlating and/or combining spectrum data for precursor ions with the spectrum data for respective product ions. For example, based on the scan function, the time of detection can be correlated to an m/z value and/or a generation of product (e.g., precursor, first-generation, etc.). For example, spectrum data can be generated for a precursor ion of a sample, the sample data can comprise an m/z value and abundance for the precursor ion, and the m/z value and abundance for any product ion generated from the precursor ion, whether first-generation, second-generation, or other generation.

Spectrum data can be combined from a first spectrum data, a second spectrum data, and optionally other spectrum data to form combined spectrum data. For example, first spectrum data can be generated from detecting a first composition comprising at least a portion of a first set of precursor ions produced from a sample, a first set of first-generation product ions produced from the first set of precursor ions, and a first set second-generation product ions produced from the first set of first-generation product ions. Second spectrum data can be generated from detecting a second set of precursor ions produced from the sample and a second set of first-generation product ions produced from the second set of precursor ions. The first and second spectrum data can be combined to correlate the precursor ions to the first-generation product ions and the second-generation product ions. For example, the second spectrum data may provide the identity of the precursor ions, the first spectrum data may provide the identity of the second-generation product ions, and the precursor ions can be matched with the second-generation product ions by the overlap of the first-generation product ions. The second spectrum data can be generated prior to, at least partially concurrently with, or after generating the first spectrum data.

The method 100 can enable efficient and rapid characterization of complex mixtures on a molecular level by providing direct measurements of m/z values (e.g., correlating to molecular weight) of the intact ionized molecules (e.g., precursor ions). The detected product ions can be used to deduce structural information (e.g., molecular substructure) based on the fragmentation patterns. The method 100 can be performed on a mass spectrometer in a time period ranging from 10 ms to 10 seconds, such as, for example, 100 ms to 5 seconds, 200 ms to 2 seconds, 200 ms to 1 second, or 300 ms to 900 ms. In various embodiments, the method 100 can be performed with a single ion injection, and the entire ion population can be characterized (by measuring precursor m/z and product m/z simultaneously) in a single analysis scan. In various non-limiting embodiments, the method 100 can comprise two ion injections and multiple spectrum data can be combined. The method 100 can increase the m/z value ranges detected and increase the consistency of product ion m/z values, while using simple scan functions.

FIG. 2 shows a non-limiting embodiment of a mass spectrometer 200 that can be used to analyze. For example, the mass spectrometer 200 can be configured to measure the m/z values of various ions generated from a sample. For example, the mass spectrometer 200 can be configured to perform the method according to FIG. 1. Referring back to FIG. 2, the mass spectrometer 200 can comprise an ionizer 220, an ion trap 222 in ion communication with the ionizer 220, a detector 224 in ion communication with the ion trap 222, and a controller 226 in signal communication with the ion trap 222 and the detector 224. In various non-limiting embodiments, the mass spectrometer comprises a single ion trap 222.

As used herein, “ion communication” means that the recited elements are configured with features such that ions, gas molecules, and/or the like can be transmitted between the two elements. In various non-limiting embodiments, the ion communication can be generation by control of ions between the recited elements by an electric field or by a physical structure (e.g., a tube, walls defining a bore).

The ionizer 220 can be in ion communication with the ion trap 222 via an ion conduit 228 suitable to transfer the sample and/or ions from the ionizer 220 to the ion trap 222 such that gases, vapors, particles entrained in a gas, and/or ions can be transferred from the ionizer 220 to the ion trap 222 through the ion conduit 228. The ion trap 222 can be in ion communication with the detector 224 by an ion conduit 230 suitable to transfer ions ejected from the ion trap 222 to the detector 224 and so that gases, vapors, particles entrained in a gas, and/or ions can flow from the ion trap 222 to the detector 224 through the ion conduit 230. The ion conduits 228 and 230 can be a suitable ion pathway, which may be generated by an electric field and/or comprise a physical structure.

The ionizer 220, as supported by the controller 226, is configured to ionize a sample, thereby generating a precursor ion or precursor ions from the sample. The ionizer 220 can be configured to perform at least one of electron ionization, photo ionization, chemical ionization, collisionally activated disassociation, electrospray ionization, and other suitable methods of ionization on the sample.

The controller 226 can be configured to control the functionality of the mass spectrometer 200. The controller 226 can be in signal communication with the ionizer 220, the ion trap 222, and the detector 224. For example, the controller 226 can communicate with the ionizer 220, the ion trap 222, and the detector 224 through physical wires and/or wireless signals. The controller 226 can comprise, for example, a processor operatively coupled to memory, a DC voltage source, an AC voltage source, and a rectifier, and may comprise other hardware components. For example, the DC voltage source, AC voltage source, and rectifier may be used to generate the scan function. The memory can comprise machine executable instructions for controlling the ionizer 220, ion trap 222, and detector 224. In various non-limiting embodiments, the memory can include instructions for analyzing the data received from the detector 224. The processor can be a microprocessor, microcontroller, or other basic computing device that incorporates the functions of a computer's central processing unit (CPU) on an integrated circuit.

The ion trap 222, as supported by the controller 226, can be configured to receive the sample and/or ions, ionize the sample, store the ions in the ion trap 222, excite at least a portion of the ions in the ion trap 222 selectively over time to fragment the ions, and/or eject ions from the ion trap 222. For example, the controller 226 can be configured to apply a scan function to the ion trap 222 to control ions within the ion trap 222. The controller 226 can generate and apply to the ion trap 222 an RF voltage, an excitation frequency, and/or an ejection frequency to create an electric field, such as, for example, an oscillating potential well within the ion trap 222 that can selectively store, excite, and/or eject ions. As the RF voltage, the excitation frequency, and/or the ejection frequency changes, the electric field within the ion trap 222 can change, which can affect the ions stored, excited, and/or ejected by the ion trap 222. In various non-limiting embodiments, the ion trap 222, in conjunction with the controller 226, can be configured to ionize the sample, thereby generating precursor ions from the sample within the ion trap 222.

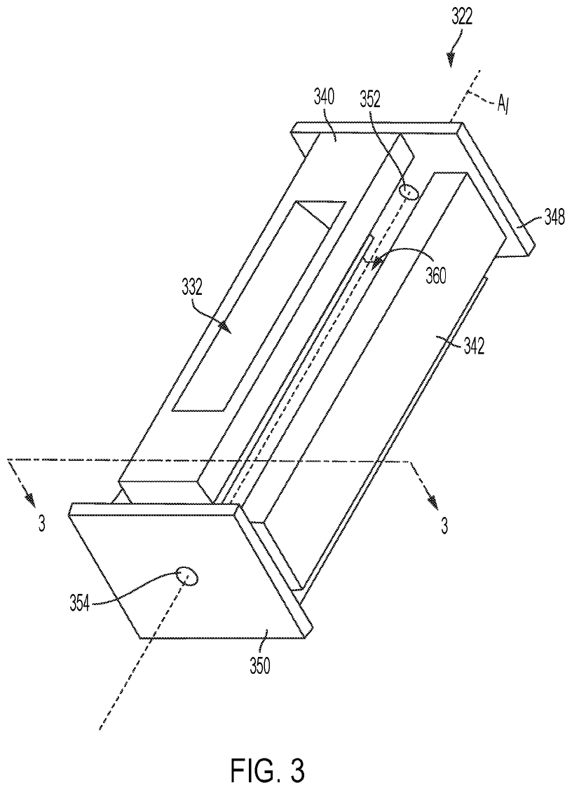

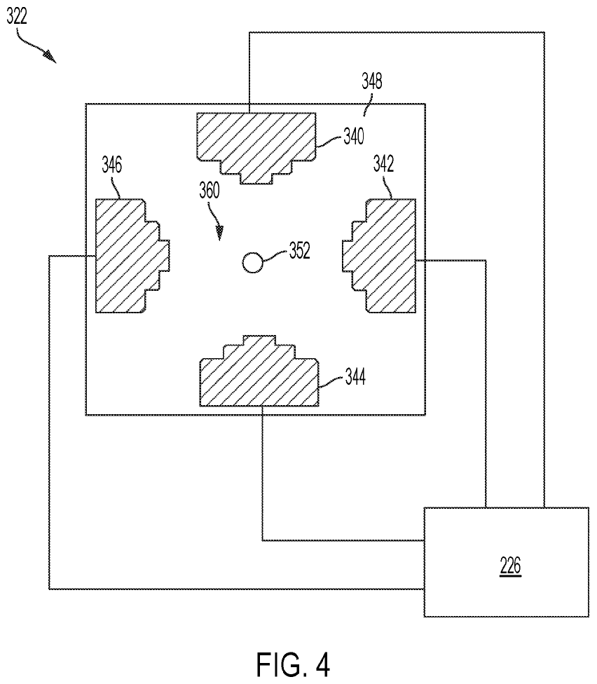

In various embodiments, the ion trap 222 can be a quadrupole ion trap, such as, for example, a 3D quadrupole ion trap, a linear quadrupole ion trap, a toroidal ion trap, a cylindrical ion trap, or a rectilinear ion trap. For example, the ion trap 222 can be a linear quadrupole ion trap 322 as illustrated in FIGS. 3 and 4. Referring to FIG. 4, the ion trap 322 can comprise four electrodes 340, 342, 344, 346 defining a cavity 360. Ions can be introduced to, stored in, excited in, and/or ejected from the cavity 360. Each electrode 340, 342, 344, and 346 can be in electrical communication with the controller 226. In various non-limiting embodiments, the ions are collisionally cooled in the ion trap 222 before performing any scan functions on the ions. Collisional cooling can reduce the kinetic energy of the ions after injection into the trap or after a first fragmentation event but prior to the scan function being applied, which can increase data quality. Collision cooling can comprise storing ions in the ion trap 222 for a period time prior to the scan function such that the ions collide with background gas molecules (e.g., nitrogen, air, helium) and lose kinetic energy.

Referring to FIG. 3, in certain embodiments the ion trap 322 can comprise caps 348 (e.g., endcaps), 350, which can be configured to confine ions along a longitudinal axis, AI, extending from cap 348 to cap 350. The caps 348, 350 can comprise bores 352, 354, respectively, that can be suitable to form ion pathways into the cavity 360 of the ion trap 322 such that gases, vapors, particles entrained in a gas, and/or ions can flow into the cavity 360 of the ion trap 322.

Referring again to FIG. 4, in various embodiments the electrodes 340, 342, 344, and 346 can be configured in sets. For example, a set of electrodes can comprise pairs of opposing electrodes, such as, for example, a first set of electrodes including electrodes 340 and 344 and a second set of electrodes including electrodes 342 and 346. In certain non-limiting embodiments, the RF voltage can be applied in a quadrupolar fashion such that a positive phase of the RF voltage can be applied to first set of opposing electrodes and a negative phase of the RF voltage can be applied to second set of opposing electrodes, where no electrode in the first set is in the second set. In various non-limiting embodiments, a single phase of the RF voltage can be applied to the first set of opposing electrodes and the second set of opposing electrodes can be virtually grounded. In certain non-limiting embodiments regarding AC signals (e.g., ejection frequency, excitation frequency), the AC signal can be applied in a dipolar fashion such that to the positive phase of the AC signal can be applied to one electrode of a first set of opposing electrodes and a negative phase of the AC signal can be applied to a second electrode in the first set of opposing electrodes.

To control the ions, the controller 226 can apply a scan function to electrodes 340, 342, 344, and 346 of the ion trap 322, such as, for example, the scan function shown in FIGS. 5A-5C, the scan function shown in FIGS. 6a-6C, and/or the scan function shown in FIGS. 9A-9D. For example, the RF voltage can be applied in quadrupolar fashion to all of electrodes 340, 342, 344, and 346 of the ion trap 322 or to one set of electrodes. In various non-limiting embodiments, the excitation frequency can be applied to all of electrodes 340, 342, 344, and 346 of the ion trap 322. The excitation frequency and ejection frequency may be applied in a dipolar fashion (e.g., 180 degrees out of phase) either on the same set of electrodes or on orthogonal electrodes pairs. In certain non-limiting embodiments, the controller 226 can be configured to apply the excitation frequency and the ejection frequency scans to a first set of electrodes. In various non-limiting embodiments, the controller 226 can be configured to apply the excitation frequency to a first set of electrodes, and to apply the ejection frequency scans to a second set of electrodes, wherein no electrode in the first set is in the second set.

In certain non-limiting embodiments, the ions are excited in the first dimension of the ion trap 322, and the excited ions are ejected in the second dimension, which differs from different the first dimension, towards a detector. As illustrated, the ion trap 322 has an opening 332 on the electrode 340, which can be aligned with the detector 224 such that the opening 332 can form the ion conduit 230.

Referring back to FIG. 2, in various non-limiting embodiments, the ion trap 222 can be configured to fragment ions within the ion trap 222. For example, the controller 226 can apply a scan function to the ion trap 222 and introduce a gas that causes the ions to collide with gas molecules within the ion trap 222, thereby creating product ions. For example, the ion trap 222, as supported by the controller 226, can fragment a precursor ion into first-generation product ions, a first-generation product ion into second-generation product ions, a second-generation product ion into a third-generation product ions, and/or another product ion.

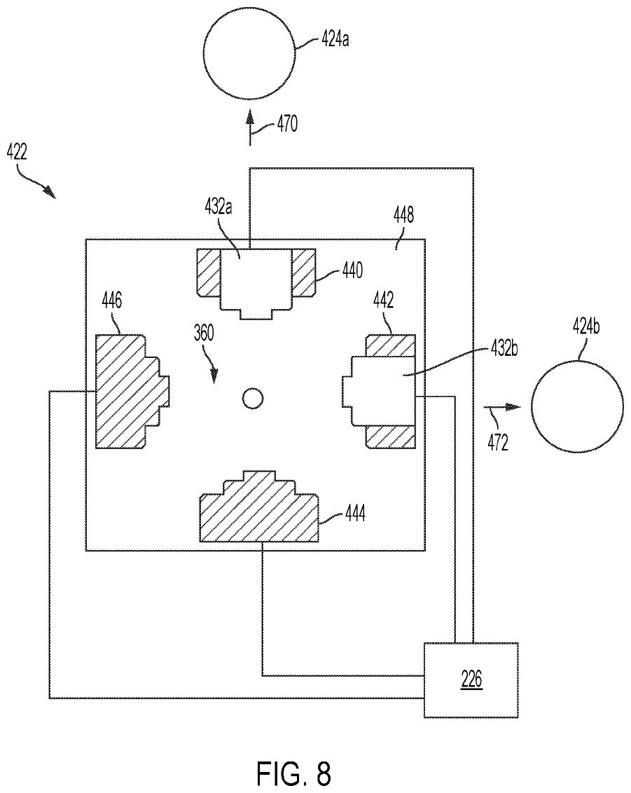

Referring to FIGS. 7 and 8, in various embodiments the ion trap 222 can be a linear quadrupole ion trap 422. The controller 226 can be configured to apply a scan function to the ion trap 422 to eject ions from the ion trap 422 in a first direction 470 and a second direction 472 different than the first direction 470. The controller 226 can be configured to eject ions from the ion trap 422 in the first direction 470 during a first time period, and to eject ions in the second direction 472 during a second time period. The first time period can at least partially overlap with the second time period, or the first time period may not overlap with the second time period.

The ion trap 422 comprises at least two openings. The openings may include, for example, a first opening 432a in the electrode 440 of the ion trap 422 configured to receive ejected ions from the ion trap 422 along a first path in the first direction 470, and a second opening 432b in the electrode 442 of the ion trap 422 configured to receive ejected ions from the ion trap 422 along a second path in the second direction 472. In various non-limiting embodiments, the first opening 432 can be oriented substantially orthogonal to the second opening 432b. As illustrated, in certain embodiments first opening 432a and second opening 432b can form the ion conduit 230.

In various non-limiting embodiments, the detector 224 can comprise at least two detectors, such as, for example, first detector 424a and second detector 424b, as illustrated in FIG. 8. For example, the first detector 424a can be in a first location and aligned with the first opening 432a such that ions ejected from the ion trap 422 in the first direction 470 are received and detected by the first detector 424a. The second detector 424b can be in a second location and aligned with second opening 432b such that ions ejected from the ion trap 422 in the second direction 472 are received and detected by the second detector 424b.

To control the ions, the controller 226 can apply a scan function to electrodes 440, 442, 444, and 446 of the ion trap 422, such as, for example, the scan function as shown in FIG. 9. For example, a first ejection frequency can be applied to a first set of two opposing electrodes of the electrodes 440, 442, 444, and 446 of the ion trap 422, a second ejection frequency can be applied to a second set of two opposing electrodes of the electrodes 440, 442, 444, and 446 of the ion trap 422, and an excitation frequency can be applied to at least one of the first set and the second set, wherein no electrode in the first set is in the second set. In various non-limiting embodiments, in order to eject ions in the first direction 470 and the second direction 472, the first ejection frequency scan is applied to electrodes 440 and 444, and the second ejection frequency scan is applied to electrodes 442 and 446.

The RF voltage can be applied in a quadrupolar fashion to all of electrodes 440, 442, 444, and 446 of the ion trap 422 or to one set of electrodes. In various non-limiting embodiments, the excitation frequency can be applied to all of electrodes 440, 442, 444, and 446 of the ion trap 322. The excitation frequency and ejection frequencies may be applied in a dipolar manner.

Referring yet again to FIG. 2, the detector 224, as supported by the controller 226, can be configured to detect ions ejected from the ion trap 222. For example, the detector 224, as supported by the controller 226, can generate data (e.g., a mass spectrum data) comprising the m/z value of the detected ions and an abundance (e.g., intensity) of the detected ions at the m/z value. In various non-limiting embodiments, the detector 224 can comprise at least one of an electron multiplier, a Faraday cup collector, a photographic and stimulation-type detector, and other detector type.

Referring back to FIG. 8, in various non-limiting embodiments comprising at least two detectors, the first detector 424a can be configured to detect ions ejected from the ion trap 422 in the first direction 470 during a first time period, and the second detector 424b can be configured to detect ions ejected from the ion trap 422 in the second direction 472 during a second time period, and the first time period at least partially overlaps with the second time period. In certain non-limiting embodiments comprising at least two detectors, the first time period does not overlap with the second time period.

Referring back to FIG. 2, the detector 224 is configured to produce data based on the ions received and detected from the ion trap 222. The detector 224 can send the data to the controller 226. In various non-limiting embodiments, the data can be processed separately and may be combined to form combined spectrum data. For example, referring to FIG. 8, a spectrum can be generated by combining first data received from the first detector 424a and second data received from the second detector 424b. The first data can be based on ions ejected from the ion trap 422 in the first direction 470, and the second data can be based on ions ejected from the ion trap 422 in the second direction 472. In various non-limiting embodiments, the controller 226 is further configured to correlate and/or combine data received from the first detector 424a and data received from the second detector 424b to produce combined spectrum data.

For a given sample, three dimensions of mass information can be acquired. For example, when a precursor ion fragments, first-generation product ions are formed. The first-generation product ions can be fragmented into second-generation product ions. The correlation of precursor ions, first-generation product ions, and second-generation product ions can be collected and analyzed to provide the three dimensions of mass information.

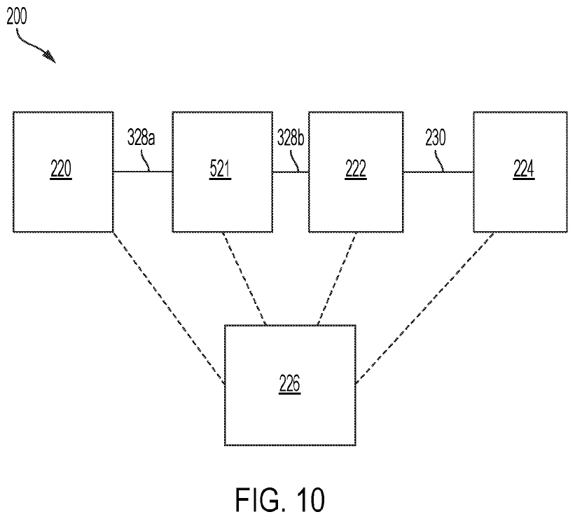

As shown in FIG. 10, the mass spectrometer 200 can optionally comprise a collision cell 521 in fluid communication with the ion trap 222 (via an ion conduit 328b) and the ionizer 220 (via an ion conduit 328a). The collision cell 521 can be configured for fragmenting at least a portion of a sample and/or ions, thereby forming a first mixture of ions prior to the ion trap 222. The first mixture can comprise one or more precursor ions and first-generation product ions formed from fragmentation of the precursor ions. In various non-limiting embodiments, the collision cell 521 can be configured for beam-type collision induced dissociation.

The first mixture can be provided to and received by the ion trap 222. The ion trap 222 can be configured to apply a scan function to the first mixture. The scan function can comprise, for example, exciting at least a portion of the first mixture selectively over time to fragment the first-generation product ions into second-generation product ions, and ejecting at least a portion of the precursor ions, the first-generation product ions, and the second-generation product ions formed from first-generation product ions from the ion trap 222. The detector 224 can be configured to detect at least a portion of the precursor ions, the first-generation product ions, and the second-generation product ions ejected from the ion trap 222 and generate spectrum data.

In various non-limiting embodiments, the ion trap 222 can be configured to fragment at least a portion of a sample by applying a first scan function, thereby forming the first mixture within the ion trap 222, and then applying a second scan function to the first mixture. The ion trap 222 can be configured for at least one of beam type collision induced dissociation within the ion trap 222 and collision induced dissociation by resonance excitation within the ion trap 222. In various non-limiting embodiments, the ion trap 222 and/or collision cell 521 can be configured to fragment at least a portion of the sample until at least third-generation product ions are formed from the sample.

### EXAMPLES

The present disclosure will be more fully understood by reference to the following examples, which provide illustrative, non-limiting embodiments. It is understood that the disclosure described in this specification is not necessarily limited to the examples described in this section.

A brassboard mass spectrometer was configured according to FIG. 2 with an ion trap configured according to ion trap 322 in FIG. 3. Various samples and scan functions were used to analyze performance of the scan functions as discussed below.

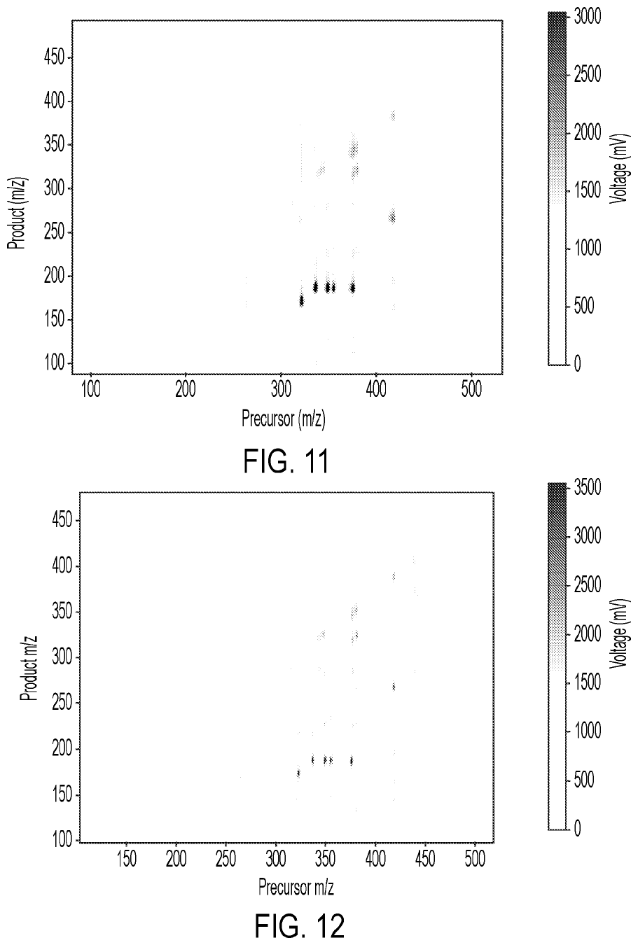

A first sample comprising fentanyl was injected into the brassboard mass spectrometer. A comparative scan function comprising a constant RF voltage was applied to the ion trap, and spectrum data as illustrated in FIG. 11 was generated based on the ions detected by the detector. A second sample, identical to the first sample, was injected into the brassboard mass spectrometer. A scan function according to FIGS. 6A-6C was applied to the ion trap, and spectrum data as illustrated in FIG. 12 was generated based on the ions detected by the detector. It was observed that the spectrum data as illustrated in FIG. 12 has an increased resolution and increased detection sensitivity compared to FIG. 11.

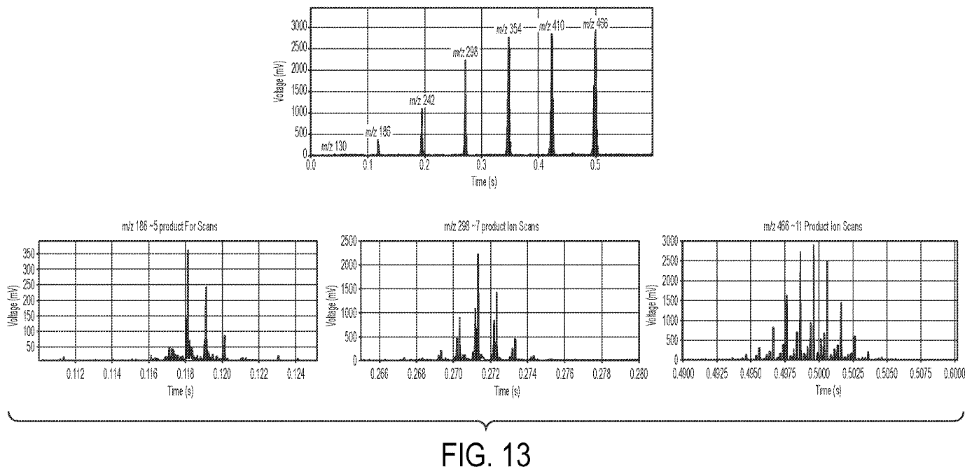

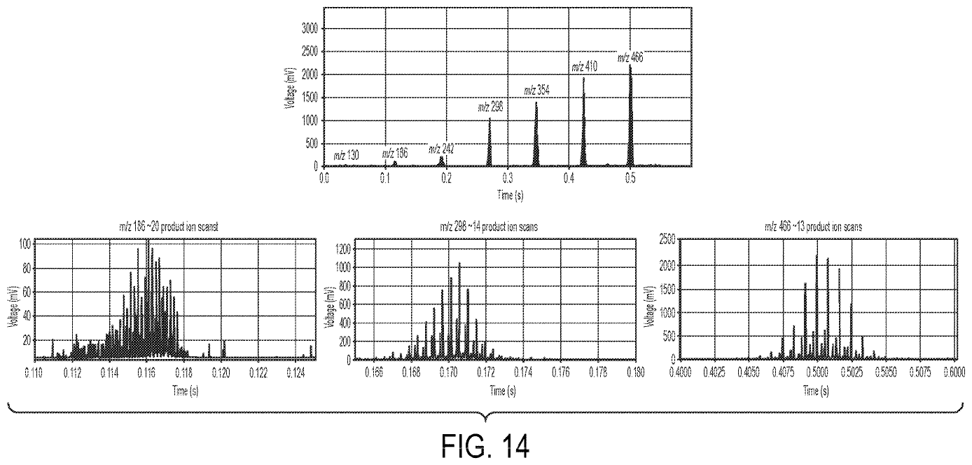

A third sample comprising quaternary ammonium ions was injected into the brassboard mass spectrometer. A comparative scan function comprising repeated ejection frequency scans with constant duration (1 ms) and constant frequency range (as in FIG. 6B, but with constant RF voltage as in FIG. 5C and sweeping excitation frequency as in FIG. 5A) was applied to the ion trap, and spectrum data as illustrated in FIG. 13 was generated based on the ions detected by the detector. A fourth sample, identical to the third sample, was injected into the brassboard mass spectrometer. A scan function according to FIGS. 5A-5C (e.g., the ejection frequency scans were of increasing duration and frequency range) was applied to the ion trap, and spectrum data as illustrated in FIG. 14 was generated based on the ions detected by the detector. As illustrated in FIG. 14, the product ions were sampled more efficiently and more frequently in the same amount of time compared to FIG. 13, resulting in increased data density and greater fidelity on the precursor ion peaks (e.g., more data points per m/z value).

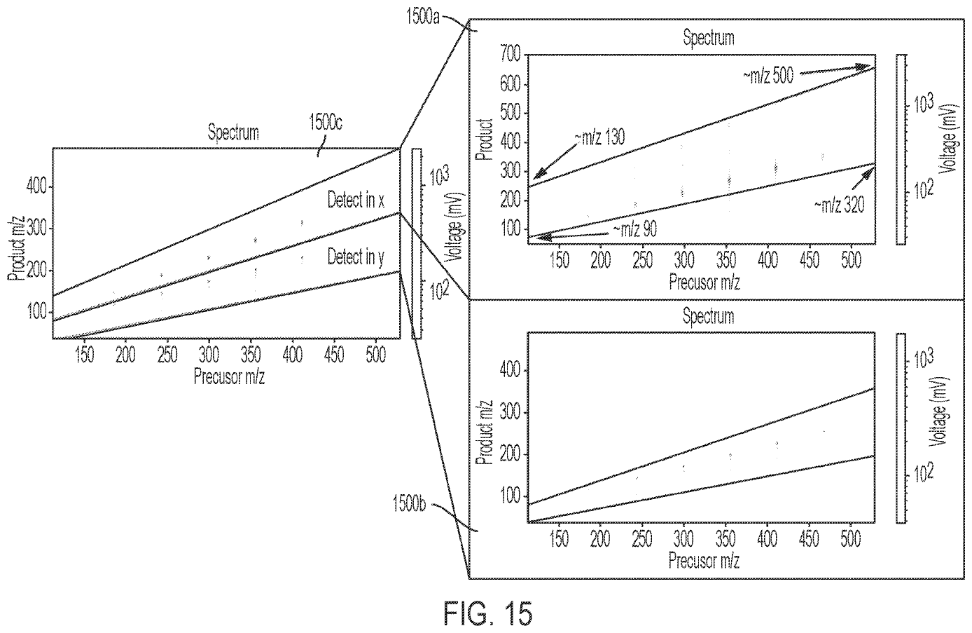

A fifth sample comprising tetraalkylammonium calibrant mixture ionized by nanoelectrospray ionization was injected into the brassboard mass spectrometer. A scan function according to FIGS. 9A, 9B, and 9D was applied to the ion trap, and spectrum data 1500a as illustrated in FIG. 15 was generated based on the ions detected by the detector.

Subsequently, a sixth sample, identical to the firth sample, was injected into the brassboard mass spectrometer. A scan function according to FIGS. 9A, 9C, and 9D was applied to the ion trap, and spectrum data 1500b as illustrated in FIG. 15 was generated based on the ions detected by the detector. The spectrum data 1500c illustrates a comparable experiment using the scan function in FIGS. 6A-6C, wherein all ions were ejected in a single dimension and detected by a single detector. The combined spectrum data from 1500a and 1500b illustrates that data from two detectors can be combined into spectrum data comparable to spectrum 1500c, enabling faster and higher resolution analysis of a sample through simultaneous mass-selective detection of multiple ions. It is believed these enhancements can be achieved with other methods and mass spectrometers according to the present disclosure.

Various aspects of non-limiting embodiments of an invention according to the present disclosure include, but are not limited to, the aspects listed in the following numbered clauses.

Clause 1. A method for analyzing a sample in a mass spectrometer, the method comprising:
storing ions produced from the sample in an ion trap of the mass spectrometer; and
applying a scan function to the ion trap comprising
   exciting at least a portion of the ions in the ion trap selectively over time to fragment precursor ions into product ions, and
   ejecting at least one of the product ions and the precursor ions from the ion trap,
   wherein the scan function comprises a constant radio frequency voltage, a sweeping excitation frequency, and successive ejection frequency scans of variable duration and variable frequency range based on the sweeping excitation frequency.

Clause 2. The method of clause 1, wherein the sweeping excitation frequency sweeps from a first frequency to a second frequency, wherein the second frequency is less than the first frequency.

Clause 3. The method of any of clauses 1-2, wherein:
the sweeping excitation frequency excites a first precursor ion at a first excitation frequency to form a first set of product ions from dissociation of the first precursor ion; and
a first scan of the successive ejection frequency scans sequentially ejects the first set of product ions from the ion trap.

Clause 4. The method of clause 3, wherein:
the sweeping excitation frequency excites a second precursor ion at a second excitation frequency to form a second set of product ions from dissociation of the second precursor ion;
a second scan of the successive ejection frequency scans sequentially ejects the second set of product ions from the ion trap, wherein the first precursor ion comprises a first mass to charge ratio less than a second mass to charge ratio of the second precursor ion and the first scan is performed for a first duration less than a second duration of the second scan.

Clause 5. The method of any of clauses 3-4, wherein the first scan of the successive ejection frequency scans spans a frequency range of a frequency corresponding to half of the radio frequency voltage to the first excitation frequency.

Clause 6. The method of any of clauses 1-5, wherein each scan of the successive ejection frequency scans comprises a frequency range greater than a frequency range of an immediately preceding scan of the successive ejection frequency scans.

Clause 7. The method of any of clauses 1-6, wherein providing ions produced from the sample into the ion trap of the mass spectrometer comprises at least one of:
ionizing the sample with an ionizer and transferring the ions to the ion trap; and
providing the sample into the ion trap and ionizing the sample in the ion trap.

Clause 8. The method of any of clauses 1-7, further comprising detecting at least a portion of at least one of the product ions and the precursor ions.

Clause 9. A mass spectrometer comprising:
an ion trap configured to receive ions of a sample; and
a controller configured to apply a scan function to the ion trap comprising:
   exciting at least a portion of ions selectively over time to fragment precursor ions into product ions, and
   ejecting at least one of the product ions and the precursor ions from the ion trap,
   wherein the scan function comprises a constant radio frequency voltage, a sweeping excitation frequency, and successive ejection frequency scans of variable duration and variable frequency range based on the sweeping excitation frequency.

Clause 10. A method for analyzing a sample in a mass spectrometer, the method comprising:
storing ions produced from the sample in an ion trap of the mass spectrometer; and
applying a scan function to the ion trap comprising
   excite at least a portion of the ions selectively over time, and
   eject at least one of product ions and precursor ions from the ion trap,
wherein the scan function comprises a sweeping radio frequency voltage, an excitation frequency, and successive ejection frequency scans, wherein the sweeping radio frequency voltage is ramped from a first voltage to a second voltage greater than the first voltage.

Clause 11. The method of clause 10, wherein each of the successive ejection frequency scans comprises an identical predetermined duration and identical predetermined frequency range.

Clause 12. The method of any of clauses 10-11, wherein each of the successive ejection frequency scans comprises an identical frequency range.

Clause 13. The method of any of clauses 10-12, wherein a frequency range of the successive ejection frequency scans spans a frequency range of a frequency corresponding to half of the radio frequency voltage to the excitation frequency.

Clause 14. The method of any of clauses 10-13, wherein a ramp from the first voltage to the second voltage is linear.

Clause 15. The method of any of clauses 10-14, wherein providing ions of the sample into the ion trap of the mass spectrometer comprises at least one of:
ionizing the sample with an ionization device and transferring the ions to the ion trap; and
providing the sample into the ion trap and ionizing the sample in the ion trap.

Clause 16. The method of any of clauses 10-15, further comprising detecting at least a portion of at least one of the product ions and the precursor ions.

Clause 17.A mass spectrometer comprising:
an ion trap configured to receive ions produced from a sample; and
a controller configured to apply a scan function to the ion trap comprising
   excite at least a portion of the ions selectively over time, and
   eject at least one of product ions and precursor ions from the ion trap,
   wherein the scan function comprises a sweeping radio frequency voltage, an excitation frequency, and successive ejection frequency scans, and the sweeping radio frequency voltage is ramped from a first voltage to a second voltage greater than the first voltage.

Clause 18. The mass spectrometer of clause 17, wherein the ion trap is a quadrupole ion trap.

Clause 19. The mass spectrometer of clause 18, wherein the quadrupole ion trap comprises one of a three-dimensional quadrupole ion trap, a linear quadrupole ion trap, a toroidal ion trap, a cylindrical ion trap, and a rectilinear ion trap.

Clause 20. The mass spectrometer of any of clauses 17-19, wherein the controller configured to apply the scan function comprises the controller to apply the excitation frequency and the successive ejection frequency scans to a first set of electrodes.

Clause 21. The mass spectrometer of any of clauses 17-20, wherein the controller configured to apply the scan function comprises the controller to apply the excitation frequency to a first set of electrodes and apply the successive ejection frequency scans to a second set of electrodes, wherein no electrode in the first set is in the second set.

Clause 22. a method for analyzing a sample in a mass spectrometer, the method comprising:
fragmenting at least a portion of the sample to form a first mixture comprising one or more precursor ions and first-generation product ions formed from dissociation of the precursor ions;
storing the first mixture in an ion trap of the mass spectrometer;
applying a scan function to the ion trap comprising
   exciting at least a portion of the first mixture selectively over time to fragment the first-generation product ions into second-generation product ions, and
   ejecting at least a portion of the precursor ions, the first-generation product ions, and second-generation product ions formed from the first-generation product ions by the scan function from the ion trap; and
detecting at least a portion of the precursor ions, the first-generation product ions, and the second-generation product ions ejected from the ion trap and generating first spectrum data.

Clause 23. The method of clause 22, wherein the fragmenting at least the portion of the sample comprises at least one of in-source collision induced dissociation, beam-type collision induced dissociation, collision induced dissociation by resonance excitation, surface-induced dissociation, infrared multiphoton dissociation, ultraviolet photodissociation, electron capture dissociation, electron transfer dissociation, and electron impact dissociation Clause 24. The method of clause 22, wherein the fragmenting at least the portion of the sample comprises beam type collision induced dissociation within a collision cell prior to the ion trap.

Clause 25. The method of clause 24, wherein the fragmenting at least the portion of the sample is performed over a range of different collision energies within the collision cell Clause 26. The method of clause 22, wherein the fragmenting at least the portion of the sample comprises at least one of beam type collision induced dissociation within the ion trap and collision induced dissociation by resonance excitation within the ion trap.

Clause 27. The method of clause 26, wherein the fragmenting at least the portion of the sample is performed at least until third-generation product ions are formed from the sample.

Clause 28. The method of any of clauses 26-27, further comprising storing the first mixture in the ion trap and collisionally cooling the first mixture in the ion trap.

Clause 29. The method of any of clauses 22-28, further comprising:
storing the sample in the ion trap of the mass spectrometer;
applying a second scan function to the ion trap comprising exciting at least a portion of the sample selectively over time to fragment a second set of precursor ions of the sample to a second set of first-generation product ions, and ejecting at least a portion of the second set of precursor ions of the sample and the second set of first-generation product ions from the ion trap;
detecting the second set of precursor ions and the second set of the first-generation product ions ejected from the ion trap and generating second spectrum data; and
combining the second spectrum data and the first spectrum data to form combined spectrum data.

Clause 30. The method of clause 29, wherein the combined spectrum data correlates the precursor ions to the first-generation product ions and the second-generation product ions.

Clause 31. The method of any of clauses 29-30, wherein generating the second spectrum data occurs prior to generating the first spectrum data.

Clause 32. The method of any of clauses 29-30, wherein generating the second spectrum data occurs after generating the first spectrum data.

Clause 33. A mass spectrometer comprising:
an ion trap configured to receive a first mixture comprising one or more precursor ions of a sample and first-generation product ions formed from the precursor ions; and
a controller configured to apply a scan function to the ion trap comprising
   excite at least a portion of the first mixture selectively over time to fragment the first-generation product ions into second-generation product ions, and
   eject at least a portion of the precursor ions, the first-generation product ions, and the second-generation product ions formed from first-generation product ions from the ion trap.

Clause 34. The mass spectrometer of clause 33, wherein the ion trap is configured to fragment at least a portion of a sample within the ion trap, thereby forming the first mixture.

Clause 35. The mass spectrometer of clause 34, wherein the ion trap is configured for at least one of in-source collision induced dissociation and beam-type collision induced dissociation.

Clause 36. The mass spectrometer of any of clauses 33-35, wherein the ion trap is a quadrupole ion trap.

Clause 37. The mass spectrometer of any of clauses 33-36, wherein the mass spectrometer comprises a single ion trap.

Clause 38. The mass spectrometer of any of clauses 33-37, further comprising a collision cell in ion communication with the ion trap, wherein the collision cell is configured for fragmenting at least a portion of a sample, thereby forming the first mixture prior to the ion trap.

Clause 39. The mass spectrometer of clause 38, wherein the collision cell is configured for beam-type collision induced dissociation.

Clause 40. The mass spectrometer of any of clauses 33-39, further comprising a detector configured to detect at least a portion of the precursor ions, the first-generation product ions, and the second-generation product ions and generate first spectrum data.

Clause 41. The mass spectrometer of claim 40, wherein
the controller is configured to apply a second scan function to the ion trap comprising
   excite at least a portion of the sample selectively over time to fragment a second set of precursor ions into a second set of first-generation product ions, and
   eject at least a portion of the second set of precursor ions and the second set of the first-generation product ions from the ion trap;
the detector is configured to detect the second set of precursor ions and the second set of first-generation product ions ejected from the ion trap and generate second spectrum data; and
the controller is configured to combine the second spectrum data and the first spectrum data to form a combined spectrum data.

Clause 42. a mass spectrometer comprising:
an ion trap;
a controller configured to apply a scan function to the ion trap to eject ions in a first direction and eject ions in a second direction different than the first direction;
a first detector in a first location relative to the ion trap and configured to detect ions ejected from the ion trap in the first direction; and
a second detector in a second location relative to the ion trap and configured to detect ions ejected from the ion trap in the second direction, wherein the second location is different than the first location.

Clause 43. The mass spectrometer of clause 42, wherein the ion trap is a quadrupole ion trap.

Clause 44. The mass spectrometer of any of clauses 42-43, wherein the scan function comprises applying a first ejection frequency to a first set of two opposing electrodes of the ion trap, applying a second ejection frequency to a second set of two opposing electrodes of the ion trap, and applying an excitation frequency to at least one of the first set and the second set, wherein no electrode in the first set is in the second set.

Clause 45. The mass spectrometer of any of clauses 42-44, wherein the ion trap comprises at least two openings comprising a first opening in a first electrode of the ion trap configured to receive ions ejected from the ion trap along a first path in the first direction, and a second opening in a second electrode of the ion trap configured to receive ions ejected from the ion trap along a second path in the second direction.

Clause 46. The mass spectrometer of clause 45, wherein the first detector is aligned with the first opening, and the second detector is aligned with the second opening.

Clause 47. The mass spectrometer of clause 46, wherein the first opening is oriented substantially orthogonal to the second opening.

Clause 48. The mass spectrometer of any of clauses 45-47, wherein the scan function comprises applying a first ejection frequency to a first set of two opposing electrodes of the ion trap, applying a second ejection frequency to a second set of two opposing electrodes of the ion trap, and applying an excitation frequency to at least one of the first set and the second set, wherein the first set comprises the first electrode and the second set comprises the second electrode and no electrode in the first set is in the second set.

Clause 49. The mass spectrometer of any of clauses 42-48, wherein at least one of the first detector and the second detector is an ion detector.

Clause 50. The mass spectrometer of any of clauses 42-49, wherein the controller is configured to correlate data received from the first detector and data received from the second detector to produce combined spectrum data.

Clause 51. The mass spectrometer of any of clauses 42-50, wherein the first detector is configured to detect ions ejected from the ion trap in the first direction during a first time period, the second detector is configured to detect ions ejected from the ion trap in the second direction during a second time period, and the first time period at least partially overlaps with the second time period.

Clause 52. The mass spectrometer of any of clauses 42-51, wherein the first detector is configured to detect ions ejected from the ion trap in the first direction during a first time period, the second detector is configured to detect ions ejected from the ion trap in the second direction during a second time period, and the first time period does not overlap with the second time period.

Clause 53. A method for analyzing a sample in a mass spectrometer, the method comprising:
providing ions produced from the sample in an ion trap of the mass spectrometer; and
applying a scan function to the ion trap comprising
exciting at least a portion of the ions selectively over time and ejecting at least one of product ions and precursor ions from the ion trap in a first direction and in a second direction different than the first direction, and
wherein the scan function comprises a radio frequency voltage, an excitation frequency, a first ejection frequency for the first direction, and a second ejection frequency for the second direction.

Clause 54. The method of clause 53, further comprising:
detecting a first portion of the ions ejected from the ion trap in the first direction at a first detector disposed at a first location relative to the ion trap; and
detecting a second portion of the ions ejected from the ion trap in a second direction at a second detector disposed at a second location relative to the ion trap, wherein the first location is different than the second location.

Clause 55. The method of clause 54, wherein the ion trap comprises at least two openings comprising a first opening in a first electrode of the ion trap configured to receive the ions ejected from the ion trap along a first path in the first direction, and a second opening in a second electrode of the ion trap configured to receive the ions ejected from the ion trap along a second path in the second direction.

Clause 56. The method of clause 55, wherein the applying a scan function comprises applying the first ejection frequency to a first set of two opposing electrodes of the ion trap, applying the second ejection frequency to a second set of two opposing electrodes of the ion trap, and applying the excitation frequency to at least one of the first set and the second set, wherein the first set comprises the first electrode and the second set comprises the second electrode and no electrode in the first set is in the second set.

Clause 57. The method of any of clauses 54-56, further comprising generating a spectrum by combining first data received from the first detector and second data received Clause 58. The method of clause 57, wherein the first data is based on ions ejected from the ion trap in the first direction and the second data is based on ions ejected from the ion trap in the second direction.

Clause 59. The method of any of clauses 54-58, wherein the first detector is configured to detect ions ejected from the ion trap in the first direction during a first time period, the second detector is configured to detect ions ejected from the ion trap in the second direction during a second time period, and the first time period at least partially overlaps with the second time period.

Clause 60. The method of any of clauses 54-59, wherein the first detector is configured to detect ions ejected from the ion trap in the first direction during a first time period, the second detector receives ions ejected from the ion trap in the second direction during a second time period, and the first time period does not overlap with the second time period.

Clause 61. The method of any of clauses 53-60, wherein the first ejection frequency for the first direction is a first frequency range, and the second ejection frequency for the second direction is a second frequency range, and the first frequency range does not overlap with the second frequency range.

In the present disclosure, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in the present disclosure is intended to include all higher numerical limitations subsumed therein. Accordingly, Applicant reserves the right to amend the present disclosure, including the claims, to expressly recite any sub-range subsumed within the ranges expressly recited. All such ranges are inherently described in the present disclosure.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

One skilled in the art will recognize that the herein described apparatus, systems, structures, methods, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

1. A method for analyzing a sample in a mass spectrometer, the method comprising:
storing ions produced from the sample in an ion trap of the mass spectrometer; and
applying a scan function to the ion trap comprising
exciting at least a portion of the ions in the ion trap selectively over time to fragment precursor ions into product ions, and
ejecting at least one of the product ions and the precursor ions from the ion trap,
wherein the scan function comprises a constant radio frequency voltage, a sweeping excitation frequency, and successive ejection frequency scans of variable duration and variable frequency range based on the sweeping excitation frequency.

2. The method of claim 1, wherein the sweeping excitation frequency sweeps from a first frequency to a second frequency, wherein the second frequency is less than the first frequency.

3. The method of claim 1, wherein:
the sweeping excitation frequency excites a first precursor ion at a first excitation frequency to form a first set of product ions from dissociation of the first precursor ion; and
a first scan of the successive ejection frequency scans sequentially ejects the first set of product ions from the ion trap.

4. The method of claim 3, wherein:
the sweeping excitation frequency excites a second precursor ion at a second excitation frequency to form a second set of product ions from dissociation of the second precursor ion; and
a second scan of the successive ejection frequency scans sequentially ejects the second set of product ions from the ion trap, wherein the first precursor ion comprises a first mass to charge ratio less than a second mass to charge ratio of the second precursor ion and the first scan is performed for a first duration less than a second duration of the second scan.

5. The method of claim 3, wherein the first scan of the successive ejection frequency scans spans a frequency range of a frequency corresponding to half of the radio frequency voltage to the first excitation frequency.

6. The method of claim 1, wherein each scan of the successive ejection frequency scans comprises a frequency range greater than a frequency range of an immediately preceding scan of the successive ejection frequency scans.

7. The method of claim 1, wherein providing ions produced from the sample into the ion trap of the mass spectrometer comprises at least one of:
ionizing the sample with an ionizer and transferring the ions to the ion trap; and
providing the sample into the ion trap and ionizing the sample in the ion trap.

8. The method of claim 1, further comprising detecting at least a portion of at least one of the product ions and the precursor ions.

9. A mass spectrometer configured to perform the method of claim 1.

10. A method for analyzing a sample in a mass spectrometer, the method comprising:
storing ions produced from the sample in an ion trap of the mass spectrometer; and
applying a scan function to the ion trap comprising
exciting at least a portion of the ions selectively over time, and
ejecting at least one of product ions and precursor ions from the ion trap, wherein the scan function comprises a sweeping radio frequency voltage, an excitation frequency, and successive ejection frequency scans, wherein the sweeping radio frequency voltage is ramped from a first voltage to a second voltage greater than the first voltage.

11. The method of claim 10, wherein each of the successive ejection frequency scans comprises an identical predetermined duration and identical predetermined frequency range.

12. The method of claim 10, wherein each of the successive ejection frequency scans comprises an identical frequency range.

13. The method of claim 10, wherein a frequency range of the successive ejection frequency scans spans a frequency range of a frequency corresponding to half of the radio frequency voltage to the excitation frequency.

14. The method of claim 10, wherein a ramp from the first voltage to the second voltage is linear.

15. The method of claim 10, wherein providing ions of the sample into the ion trap of the mass spectrometer comprises at least one of:
ionizing the sample with an ionization device and transferring the ions to the ion trap; and
providing the sample into the ion trap and ionizing the sample in the ion trap.

16. The method of claim 10, further comprising detecting at least a portion of at least one of the product ions and the precursor ions.

17. A mass spectrometer comprising:
an ion trap configured to receive ions produced from a sample; and
a controller configured to apply a scan function to the ion trap comprising
excite at least a portion of the ions selectively over time, and
eject at least one of product ions and precursor ions from the ion trap,
wherein the scan function comprises a sweeping radio frequency voltage, an excitation frequency, and successive ejection frequency scans, and the sweeping radio frequency voltage is ramped from a first voltage to a second voltage greater than the first voltage.

18. The mass spectrometer of claim 17, wherein the ion trap is a quadrupole ion trap and the quadrupole ion trap comprises one of a three-dimensional quadrupole ion trap, a linear quadrupole ion trap, a toroidal ion trap, a cylindrical ion trap, and a rectilinear ion trap.

19. (canceled)

20. The mass spectrometer of claim 17, wherein the controller configured to apply the scan function comprises the controller to apply the excitation frequency and the successive ejection frequency scans to a first set of electrodes.

21. The mass spectrometer of claim 17, wherein the controller configured to apply the scan function comprises the controller to apply the excitation frequency to a first set of electrodes and apply the successive ejection frequency scans to a second set of electrodes, wherein no electrode in the first set is in the second set.

22-61. (canceled)
